(19) United States
(12) Patent Application Publication
(10) Pub. No.: US 2017/0334092 A1
(43) Pub. Date: Nov. 23, 2017

(54) CUTTING ARM ASSEMBLY FOR TILE CUTTER

(71) Applicant: REXON INDUSTRIAL CORP., LTD., Taichung (TW)

(72) Inventor: Chun-Ti WUNG, Taichung (TW)

(21) Appl. No.: 15/599,697

(22) Filed: May 19, 2017

(30) Foreign Application Priority Data
May 20, 2016 (TW) 105115664

(51) Int. Cl. B28D 1/04; B28D 1/22

(52) U.S. Cl. CPC B28D 1/042; B28D 1/225

(57) ABSTRACT

A cutting arm assembly used in a tile cutter is disclosed to include a swing arm pivotally connected with a bottom end thereof to a worktable and having first and second through holes disposed near an opposing top end thereof, a first supporting tube having one end thereof affixed to a saw-cutting device and an opposite end thereof fastened to the first through hole of the swing arm with a first mounting device set, and a second supporting tube having one end thereof affixed to the saw-cutting device and an opposite end thereof fastened to the second through hole of the swing arm with a second mounting device set. Thus, the cutting arm assembly has a simple structure capable of providing excellent support to the saw-cutting device and facilitating installation and maintenance.

### BACKGROUND OF THE INVENTION

### 1. Field of the Invention

The present invention relates to tile cutter technology and more particularly, to a cutting arm assembly for tile cutter.

### 2. Description of the Related Art

In the use of a tile cutter, the tile is first placed on the worktable during operation, and then the tile is moved with the worktable toward the saw-cutting device, and at this time, the user can force the saw-cutting device downwardly against the tile, and thus, the tile is cut into the desired size during the movement.

However, in the prior art techniques, in order to provide sufficient support to the saw-cutting device, the saw arm has a certain configuration, and further, the saw arm is welded to the saw-cutting device. Thus, the maintenance of the saw-cutting device is more troublesome. Therefore, there is room for improvement on the structure of a conventional saw arm.

### SUMMARY OF THE INVENTION

The present invention has been accomplished under the circumstances in view. It is the main object of the present invention to provide a cutting arm assembly for a tile cutter, which has the characteristics of simple structure having good support strength and ease of installation and maintenance.

To achieve this and other objects of the present invention, a cutting arm assembly is used in a tile cutter comprising a worktable and a saw-cutting device disposed above said worktable. The cutting arm assembly comprises a swing arm, a first supporting tube, a second supporting tube, a first mounting device set and second mounting device set. The swing arm comprises a top end, a first through hole disposed near the top end, a second through hole spaced below the first through hole, and an opposing bottom end pivotally connected to the worktable. The first supporting tube has one end thereof fixedly fastened to the saw-cutting device, and an opposite end thereof inserted into the first through hole of the swing arm. The first mounting device set is mounted on the first supporting tube to affix the first supporting tube to the swing arm. The second supporting tube has one end thereof fixedly fastened to the saw-cutting device, and an opposite end thereof inserted into the second through hole of the swing arm. The second mounting device set is mounted at the second supporting tube to affix the second supporting tube to the swing arm.

Thus, the cutting arm assembly utilizes the first and second supporting tubes to give excellent support to the saw-cutting device, and also utilizes up and down swinging motion of the swing arm to drive the saw-cutting device in performing a cutting operation. Further, the use of the first and second mounting device sets facilitates the installation and maintenance of the first and second supporting tubes.

Other and further advantages and features of the present invention will be understood by reference to the following specification in conjunction with the accompanying drawings.

### BRIEF DESCRIPTION OF THE DRAWINGS

FIG. 1 is an oblique top elevational view of a tile cutter equipped with a cutting arm assembly in accordance with a first embodiment of the present invention.

FIG. 2 is an exploded view of the cutting arm assembly in accordance with the first embodiment of the present invention.

FIG. 3 is a sectional partial view of the first embodiment of the present invention, illustrating the relationship between the first supporting tube and the first mounting device set.

FIG. 4 is another sectional partial view of the first embodiment of the present invention, illustrating the relationship between the second supporting tube and the second mounting device set.

FIG. 5 is an oblique top elevational view of a cutting arm assembly in accordance with a second embodiment of the present invention.

FIG. 6 is an exploded view of the cutting arm assembly in accordance with the second embodiment of the present invention.

FIG. 7 is sectional partial view of the second embodiment of the present invention, illustrating the relationship between the first supporting tube and the first mounting device set.

### DETAILED DESCRIPTION OF THE INVENTION

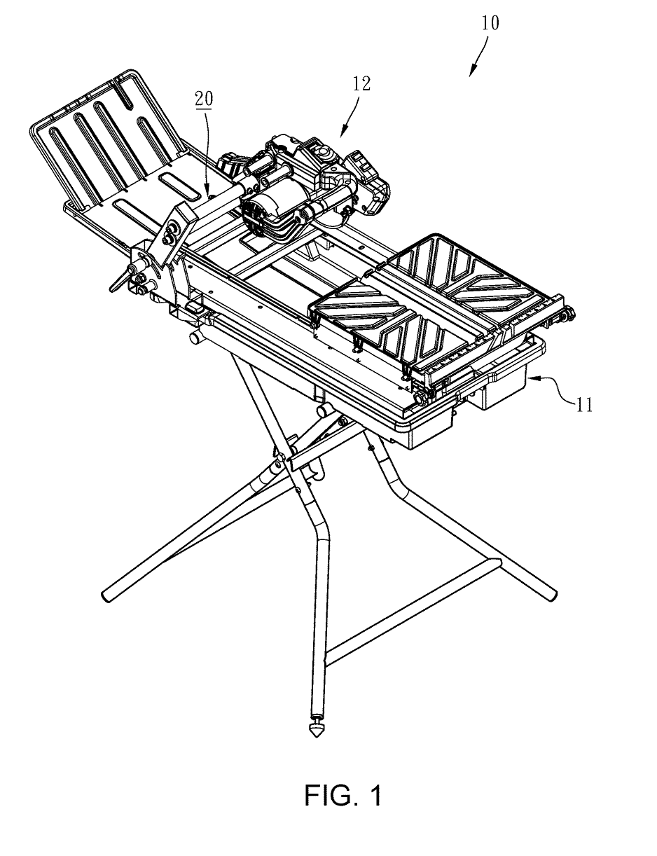

Referring to FIG. 1, a tile cutter 10 generally comprises a worktable 11, and a saw-cutting device 12 mounted at a top side of the worktable 11. The saw-cutting device 12 comprises a saw blade holder base 13, a saw blade 14 disposed above the saw blade holder base 13, and a motor 15 mounted at the saw blade holder base 13 and coupled with the saw blade 14. Since tile cutters are generally known, the applicant will not repeat the details of the structure and operating principle beyond the particulars of the invention.

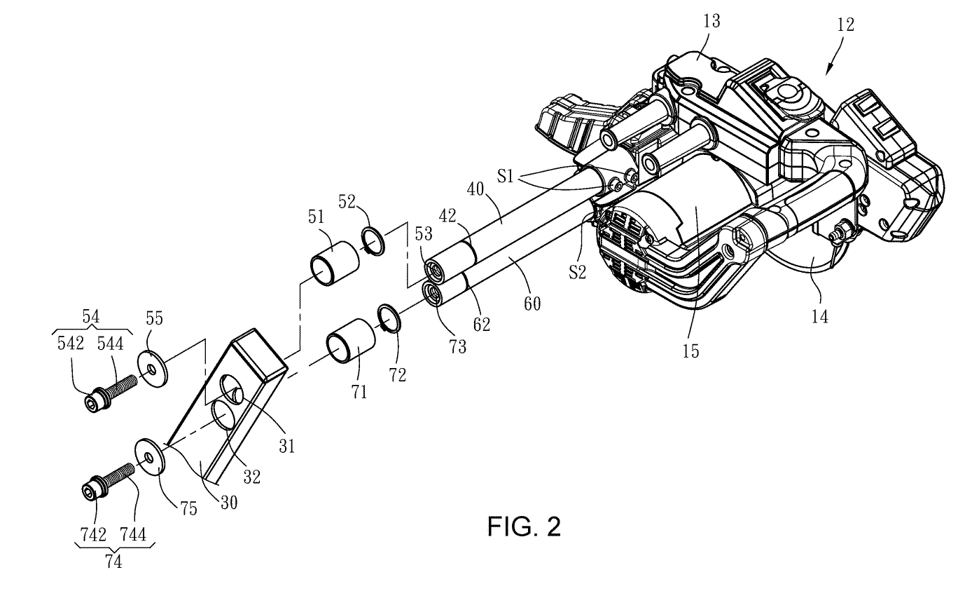

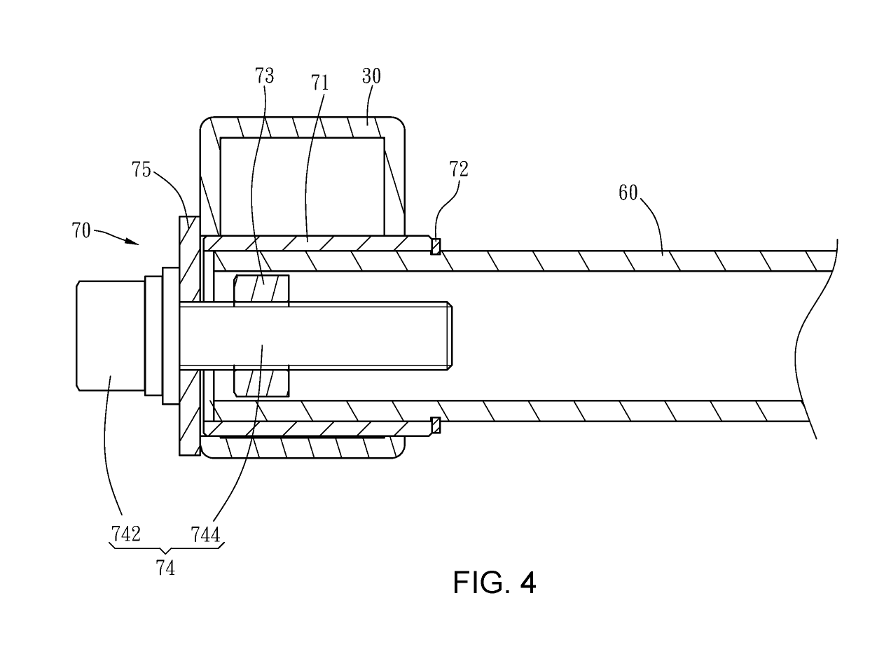

Referring to FIGS. 2-4, a cutting arm assembly 20 is used in the tile cutter 10. The cutting arm assembly 20 comprises a swing arm 30, a first supporting tube 40, first mounting device set 50, a second supporting tube 60, and a second mounting device set 70.

The swing arm 30 comprises a first through hole 31 disposed near a top end thereof, and a second through hole 32 disposed at a bottom side relative to the first through hole 31. Further, the swing arm 30 has an opposing bottom end thereof pivotally connected to one lateral side of the worktable 11.

The first supporting tube 40 has an inner end thereof fixedly fastened to the saw blade holder base 13 of the saw-cutting device 12 with two screw bolts S1, and an opposite outer end thereof inserted into the first through hole 31 of the swing arm 30.

Further, the first supporting tube 40 has a first retaining groove 42 extended around the periphery near the outer end thereof.

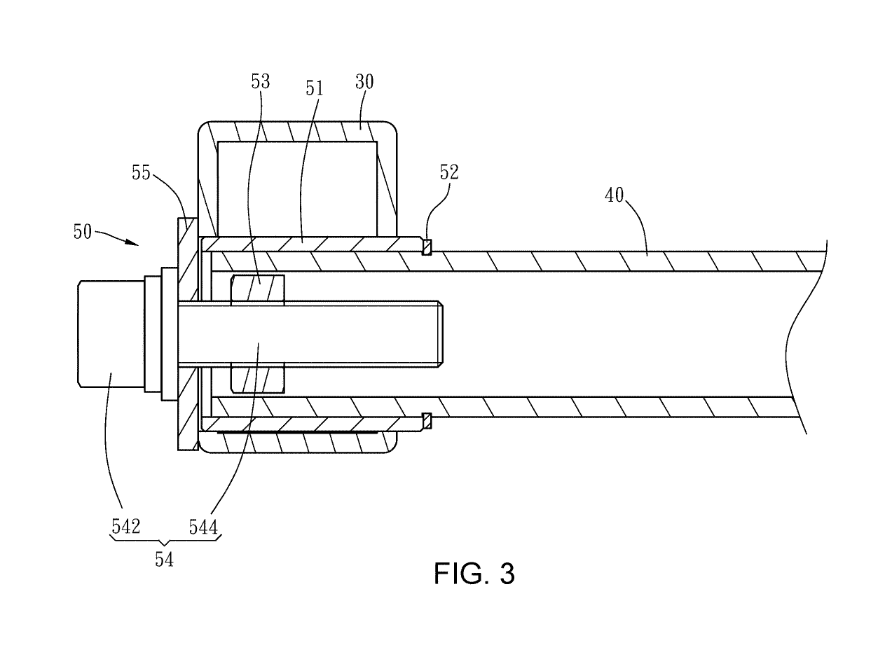

As illustrated in FIGS. 2 and 3, the first mounting device set 50 comprises a first bushing 51, a first retaining ring 52, a first screw nut 53, a first screw bolt 54, and a first washer 55. The first bushing 51 is mounted in the first through hole 32 of the swing arm 30 and sleeved onto the outer end of the first supporting tube 40. The first retaining ring 52 is mounted in the first retaining groove 42 of the first supporting tube 50 and stopped against one end of the first bushing 51. The first screw nut 53 is fixedly embedded in the outer end of the first supporting tube 40. The first screw bolt 54 comprises a head 542 and a threaded shank 544 extended from the head 542. By means of the threaded shank 544, the first screw bolt 54 is fastened to the first screw nut 53. The first washer 55 is mounted onto the threaded shank 544 of the first screw bolt 54 and stopped between an outer surface of the swing arm 30 and an inner surface of the head 542 of the first screw bolt 54. Thus, the outer end of the first supporting tube 40 is fastened to the swing arm 30 by the first mounting device set 50.

As illustrated in FIGS. 2-4, the second supporting tube 60 is equal to the first supporting tube 40 in size. The second supporting tube 60 has an inner end thereof fixedly fastened to the saw blade holder base 13 of the saw-cutting device 12 with two screw bolts S2 (only one screw bolt S2 is shown in FIG. 2), and an opposite outer end thereof inserted into the second through hole 32 of the swing arm 30. Further, the second supporting tube 60 has a second retaining groove 62 extended around the periphery near the outer end thereof.

The second mounting device set 70 comprises a second bushing 71, a second retaining ring 72, a second screw nut 73, a second screw bolt 74, and a second washer 75. The second bushing 71 is inserted into the second through hole 32 of the swing arm 30 and sleeved onto the outer end of the second supporting tube 60. The second retaining ring 72 is mounted in the second retaining groove 62 of the second supporting tube 60 and stopped against one end of the second bushing 71. The second screw nut 73 is fixedly embedded in the outer end of the second supporting tube 60. The second screw bolt 74 comprises a head 742, and a threaded shank 744 extended from the head 742. By means of the threaded shank 744, the second screw bolt 74 is fastened to the second screw nut 73. The second washer 75 is mounted onto the threaded shank 744 of the second screw bolt 74 and stopped between the outer surface of the swing arm 30 and an inner surface of the head 742 of the second screw bolt 74. Thus, the outer end of the second supporting tube 60 is fastened to the swing arm 30 by the second mounting device set 70.

As can be seen from the above, the cutting arm assembly 20 utilizes up and down swinging motion of the swing arm 30 to drive the saw-cutting device 12 in performing a cutting operation. During the up and down swinging motion of the swing arm 30, the first and second supporting tubes 40,60 give excellent support to the saw-cutting device 12. Further, the use of the first and second mounting device sets 50,70 facilitates the installation and maintenance of the first and second supporting tubes 40,60.

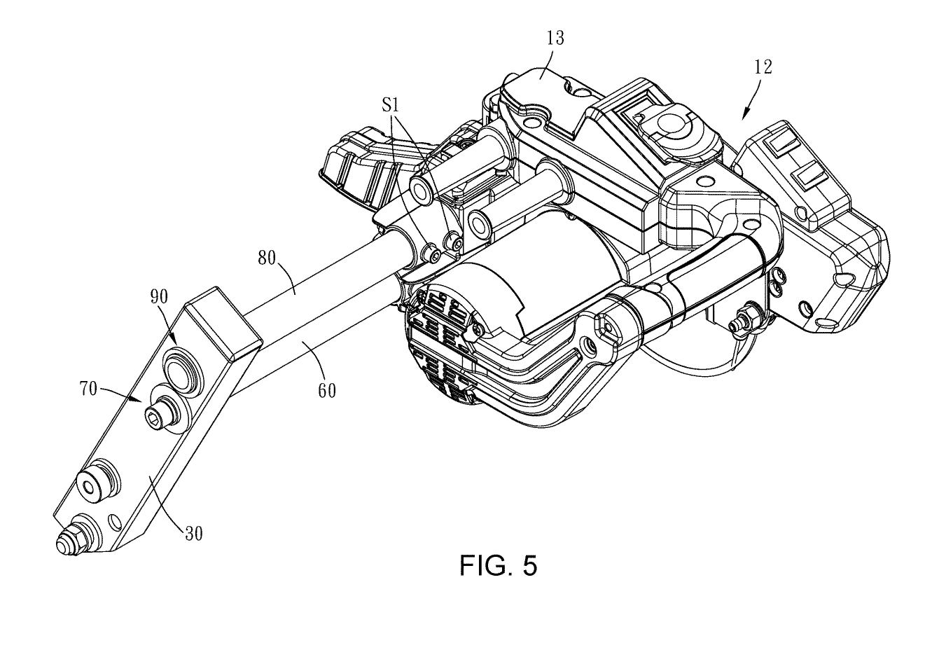

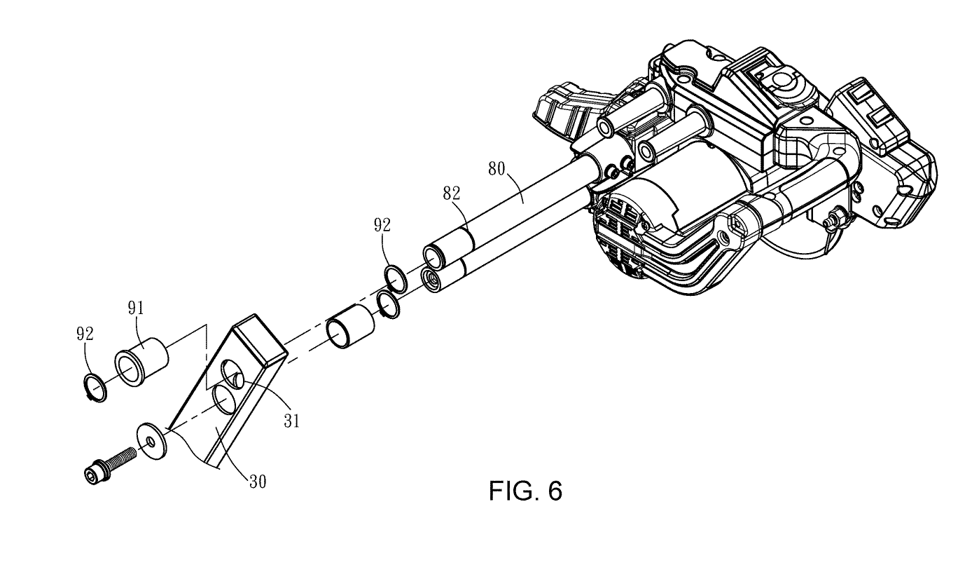

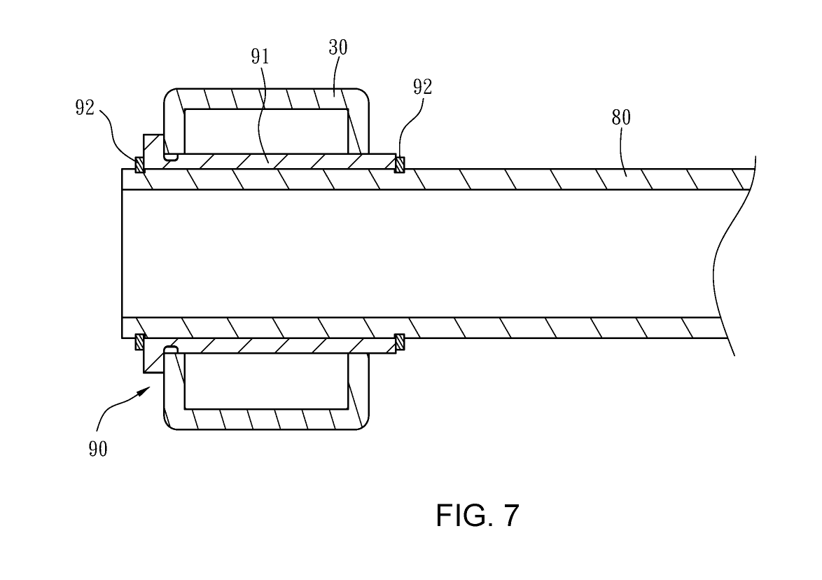

Referring to FIGS. 5-7, a second embodiment of the present invention is shown. According to this second embodiment, the first supporting tube 80 and the first mounting device set 90 are different in structure when compared to the like components in the above-described first embodiment; the second supporting tube 60 and the second mounting device set 70 of this second embodiment are same as the like components in the above-described first embodiment.

The first supporting tube 80 has the inner end thereof fixedly fastened to the saw blade holder base 13 of the saw-cutting device 12 with two screw bolts S1, and the opposing outer end thereof inserted into the first through hole 31 of the swing arm 30. Further, the first supporting tube 80 has two first retaining grooves 82 extended around the periphery thereof and spaced from each other at a distance.

The first mounting device set 90 comprises a first bushing 91 and two first retaining rings 92. The first bushing 91 is mounted in the first through hole 31 of the swing arm 30 and attached onto the outer end of the first supporting tube 80. The two first retaining rings 92 are respectively fastened to the two first retaining grooves 92 of the first supporting tube 80 and respectively abutted against the two opposite ends of the first bushing 91. Thus, the outer end of the first supporting tube 80 is firmly secured to the swing arm 30 by the first mounting device set 90.

As can be seen from above, the second embodiment of the present invention omits the arrangement of the aforesaid first screw nut 53 and first screw bolt 54, and thus, the user can insert an exposed wire member (such as the power cable of the motor 15) from the outer end of the first supporting tube 80 into the inside of the first supporting tube 80 to keep the wire member from sight, enhancing the operational safety and maintaining the sense of beauty of the overall appearance.

What is claimed is:

1. A cutting arm assembly used in a tile cutter comprising a worktable and a saw-cutting device disposed above said worktable, the cutting arm assembly comprising:
a swing arm comprising a top end, a first through hole disposed near said top end, a second through hole spaced below said first through hole and an opposing bottom end pivotally connected to said worktable;
a first supporting tube having one end thereof fixedly fastened to said saw-cutting device and an opposite end thereof inserted into said first through hole of said swing arm;
a first mounting device set mounted on said first supporting tube to affix said first supporting tube to said swing arm;
a second supporting tube having one end thereof fixedly fastened to said saw-cutting device and an opposite end thereof inserted into said second through hole of said swing arm; and
a second mounting device set mounted at said second supporting tube to affix said second supporting tube to said swing arm.

2. The cutting arm assembly as claimed in claim 1, wherein said first supporting tube comprises two first retaining grooves extended around the periphery thereof and spaced from each other; said first mounting device set comprises a first bushing mounted in said first through hole of said swing arm and attached onto one end of said first supporting tube and two retaining rings respectively mounted in said first retaining grooves of said first supporting tube and respectively abutted against two opposite ends of said first bushing.

3. The cutting arm assembly as claimed in claim 1, wherein said first supporting tube comprises a first retaining groove extended around the periphery near one end thereof; said first mounting device set comprises a first bushing, a first retaining ring, a first screw nut, a first screw bolt and a first washer, said first bushing being mounted in said first through hole of said swing arm and attached onto one end of said first supporting tube, said first retaining ring being mounted in said first retaining groove of said first supporting tube and abutted against one end of said first bushing, said first screw nut being embedded in one end of said first supporting tube, said first screw bolt comprising a head and a threaded shank extended from said head and fastened to said first screw nut, said first washer being mounted on said threaded shank of said first screw bolt and stopped between an outer surface of said swing arm and an inner surface of said head of said first screw bolt.

4. The cutting arm assembly as claimed in claim 1, wherein said second supporting tube comprises a second retaining groove extended around the periphery near one end thereof; said second mounting device set comprises a second bushing, a second retaining ring, a second screw nut, a second screw bolt and a second washer, said second bushing being mounted in said second through hole of said swing arm and attached onto one end of said second supporting tube, said second retaining ring being mounted in said second retaining groove of said second supporting tube and abutted against one end of said second bushing, said second screw nut being embedded in one end of said second supporting tube, said second screw bolt comprising a head and a threaded shank extended from said head and fastened to said second screw nut, said second washer being mounted on said threaded shank of said second screw bolt and stopped between an outer surface of said swing arm and an inner surface of said head of said second screw bolt.

5. The cutting arm assembly as claimed in claim 1, wherein said first supporting tube and said second supporting tube are arranged in parallel.

6. The cutting arm assembly as claimed in claim 1, wherein said first supporting tube and said second supporting tube are equal in size.
